(19) United States
(12) Patent Application Publication
(10) Pub. No.: US 2010/0007503 A1
(43) Pub. Date: Jan. 14, 2010

(54) ALARM SYSTEM

(76) Inventor: Robert Carrington, Hale (GB)

Correspondence Address: Thomas M. Galgano, 20 W. Park Avenue, Suite 204, Long Beach, NY, 11561, US

(21) Appl. No.: 12/499,482

(22) Filed: Jul. 8, 2009

(30) Foreign Application Priority Data
Jul. 8, 2008 (GB) GB0812476.0

(51) Int. Cl. G08B 23/00

(52) U.S. Cl. 340/573.1

(57) ABSTRACT

An automated method and computer system for monitoring a person's safety which allows a person to input a time by which the person is to confirm their safety and input a time period calculated from the inputted time should the person be delayed in confirming their safety. The system contacts the person if no confirmation is received by expiry of the specified time period and alerts a security service to register a lack of confirmation and that the person may be in danger.

### FIELD OF THE INVENTION

The present invention is in the technical field of an alarm system to improve personal safety. In particular, the system provides for more rapid alerting of security services to a potential threat to an individual.

### BACKGROUND TO THE INVENTION

In recent years, the dangers, either real or perceived associated with meeting new people has increased. Apart from a general rise in crime levels and an awareness by the public of an increase, in particular, of violent crimes, the methods by which people get in contact with and subsequently to know each other is also changing. However, such increased dangers are also associated with a person when out alone and the current invention can be equally applied to these situations.

With the advent of the widespread availability and ease of use of the internet, this medium is now of increasing importance in relational areas. One aspect which has particularly blossomed is that of dating. By means of the internet, information can be exchanged between parties leading to a build-up of a level of trust between the parties. However, particularly (although not exclusively) with respect to the internet, the information provided can be easily falsified leading to the wrong perception of an individual: the lack of a face-to-face meeting facilitating any deception. A result of this is that people, especially women, often have concerns about meeting people personally, whom they have got to know (at a distance).

It should be emphasized however, that the hereindisclosed invention is not solely for use in respect of internet mediated relationships, but is more generally applicable. For example, where a person has a medical condition, such as diabetes, then the system can be used to ensure that monitoring is taking place and should that person be incapacitated then they have the assurance that an alarm would be raised.

In order to provide safeguards, a number of means have been implemented of ensuring that an alert is raised should the suspicion arise of any danger to a person. The simplest of these is for a person going out alone or to a meeting to tell a third party when they expect to arrive back. This method has a number of drawbacks however. Firstly, the third party may simply not notice when the time has passed, particularly if that time is when they would normally be asleep. Secondly, the third party may not wish to raise an alarm immediately the stated time has passed; possibly out of fear of embarrassment should the alarm be false.

The delay occasioned, which could be long, may be critical in the event of an incident taking place. A second, similar means, is for the person going to the meeting to agree to contact, often by telephone, a third party at a specified time. This approach suffers from the same drawbacks as the first named means above.

Mobile telephones have greatly improved the situation as they enable contact to be made from almost any location and also for the whereabouts of that telephone to be tracked. Again however, in a difficult situation it may be impossible for the users to make a call. Many telephones are configured such that a single key press (often referred to as a panic button), of a type often seen in sheltered accommodation, is sufficient to alert the appropriate authorities. Again however these keys presuppose access to the telephone.

### SUMMARY OF THE INVENTION

In order to address the above difficulties, the present invention firstly contemplates the provision of an organization and in particular an organization of or through an internet website, which organization is responsible for logging when certain events should take place, and in the absence of said events, taking steps to raising an alarm and alerting the police or other security authority to the possible danger to a person.

The events in particular preferably involve a specifically designated contact between a person being monitored by the organization and another party associated therewith.

The invention further contemplates a system and method of monitoring and a device to incorporate said system.

Accordingly in a first aspect of the invention, there is provided a method of monitoring a person's safety, the method comprising the steps of,
i) inputting a time by which a person is to confirm their safety;
ii) inputting a time period, said time period being calculated from the above in step i);
iii) contacting a person if no confirmation received by expiry of the time period;
iv) alerting a security service to register a lack of confirmation and that the person may be in danger.

The above system is automated which reduces the possibility of an error occurring. When embarking on a meeting therefore, the person logs onto a website which hosts the system. The user enters the information that they are to go on a date or attend a meeting and specifies a time by which they should communicate with the system that they have returned to their home or office safely. The user also specifies a time period so that should they be delayed in making said communication, the alert system will not be triggered too precipitately. The time period is set by the user and can be from 0-150 minutes, dependent on the person and the meeting which is to take place. Again, to ensure that there is not a too precipitate alerting of the security authorities, the system, on expiry of the time period contacts a person and requests confirmation of their safety. Should no confirmation be received then the security authorities are notified.

The system is operated and hosted on a central computer remove from the user. A user on joining up to use the system, is given a username and password to enable the user to access a central computer and change the details required. In order to enable operation, the computer includes a name-memory portion to store the name of the user. Associated with the name-memory portion are further memory blocks to retain contact details and other relevant information. The computer also includes a time-memory portion to retain the time input by a user and a further time-period memory portion to retain an input time period upon expiry of which first communication from the system to the user occurs. In addition to the above stored data, a database of contact names along with contact details is maintained. Said contact names are accessible upon expiry of the time or time period.

Optionally, the user specifies a password which must be input to register that they are safe. The requirement of a password allows a further layer of security for the user.

Preferably, a user inputs a specific further contact which the system contacts first in the event of the time period expiring. In the event therefore that the user either cannot reach the system or finds it easier to have reached said first contact, then they can ensure that security authorities are not necessarily contacted in the event that the user is safe. Further preferably, a plurality of further contacts is specified to increase the flexibility to the user to deactivate the system from raising an alert. In general however, two or more further contacts may be undesirable due to the increased time required for the system to check each of the further contacts.

Conveniently, communication between the system and the user and the system and the contact or further contacts is by a text message. This means of communication has the benefit of being rapid, cheap but also more accessible as text messages are known to get through to a recipient or to be capable of being sent far more easily than voice messages.

### BRIEF DESCRIPTION OF THE FIGURE

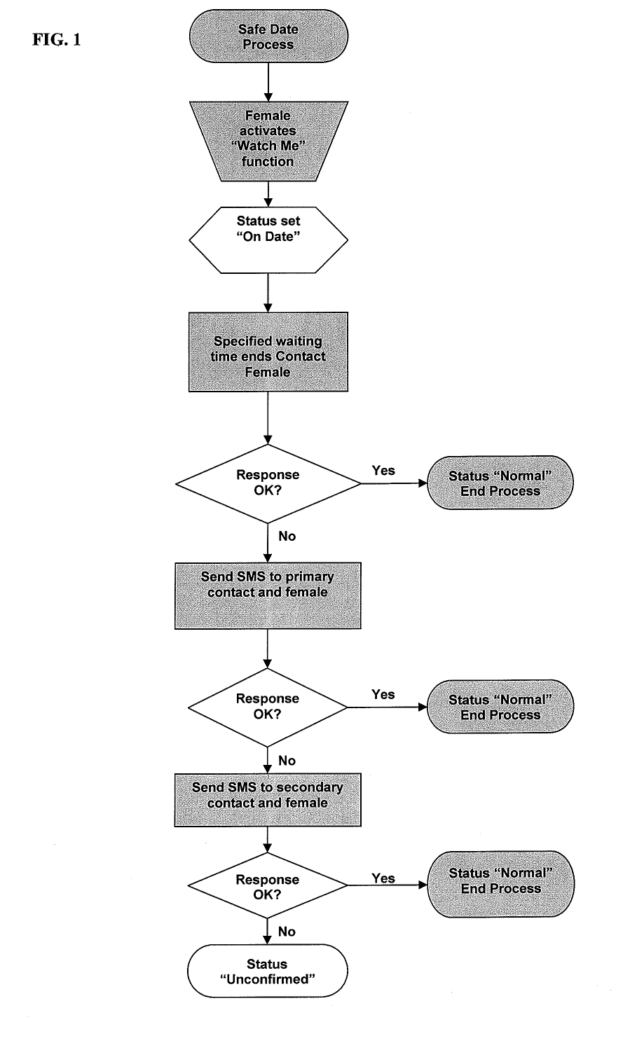

The invention is now described with reference to the accompanying flow chart in FIG. 1, which figure shows an embodiment of a system for improving a person's safety and security.

### DETAILED DESCRIPTION OF THE INVENTION

Referring to FIG. 1, this exemplifies a process by which a person, in this case a woman, submits details of a date on which she is to go, and the subsequent checking process to determine if she has carried out certain actions to confirm her safety. Moreover, steps are also defined in the event that no such confirmation has been received. The system is intended to be run through an internet-accessed site hosted on a central computer.

The woman in question, having registered with the site goes into the site and enters the specified area. Typically, said area is accessed by means of an allocated user name and a password to ensure that data entered cannot be accessed or altered by unauthorized persons.

Data is inputted into the system to register the woman going on the date and fields on the screen are available to input an estimated time of return, along with a further time period beyond the time of return. If the woman has not registered herself as being safe after the end of this further time period, this system will contact the first person in a list of contacts. The said list of contacts can already have been stored in the system or amended at the time of registering the date.

Additionally, at the time of registering the date a specific action can also be input as being the sign that a woman is safe. Such an action can for example be a password known only to the woman and the system.

Once all the data has been input, the system is activated to await the input actions and the status is set to “on-date”.

If the time of return entered by the woman is passed without her having entered the safety action required into the system, then the system contacts the woman to determine if she is safe. Should no response be received, the system enters a waiting mode for the further time period set by the woman at the end of which period, if no response has been received, the system contacts the first person on the list and requests confirmation of the woman's safety. Additionally, if so required by the user, a copy of said reminder can additionally be sent to herself.

In the event that a response is sent back by the first contact to the effect that the user is safe then the system sets to “normal” and the reminder process is ended.

Should no response be filed to the effect that the user is safe, the next stage for process is triggered. Said next stage is predetermined by the user on setting up the date process at the beginning. If the user has specified a second contact then, in the event that a “no contact” response is received from the first contact then the second contact is likewise activated. Said process is repeated, in the event of further “no contact” responses, until a response has been received from the last designated contact. In the event that the final contact also registers a “no contact”, then the appropriate authorities are contacted and informed of the situation.

In an alternative embodiment of the above process, the initial contact made by the system, in the event of no safety confirmation having been received at the designated time, is with the first contact and not the user. In a further embodiment, the system first contacts either the user or the first contact in the event that the further time period, beyond the initial set time is past. The further time period is determined by the user and can be up to 150 minutes.

The type of contact to be made between the parties is determined by the system and the user. For simplicity, speed and to give the best contacts, it is envisaged that a text message based system be implemented.

It will of course be understood that the invention is not limited to the specific details described herein, which are given by way of example only, and that various modifications and alterations are possible within the scope of the invention.

What is claimed is:

1. A method of monitoring a person's safety, comprising the steps of:
v) inputting a time by which a person is to confirm their safety;
vi) inputting a time period, said time period being calculated from said time in step i);
vii) contacting the person if no confirmation is received by expiry of said time period; and
viii) alerting a security service to register a lack of confirmation and that the person may be in danger.

2. An automated computer system for monitoring a person's safety, comprising:
a central computer remote from a person;
means for the person to access said central computer;
means for the person to enter information including a specific time by which the person will communicate with said system and a time period should the person be delayed in communicating with said system;
means for storing said information;
means for the system upon expiry of said time period to contact the person and request confirmation of their safety; and,
means for alerting security authorities should no confirmation of the person's safety be received by said system.
